(19) United States
(12) Patent Application Publication
(10) Pub. No.: US 2002/0149785 A1
(43) Pub. Date: Oct. 17, 2002

(54) Automatic printer color correction based on characterization data of a color ink cartridge

(76) Inventors: Chia-Lin Chu, Cypress, TX (US); Gokalp Bayramoglu, Houston, TX (US); Henry M. D'Souza, Cypress, TX (US); Tam Q. Duong, Houston, TX (US)

Correspondence Address: AKIN, GUMP, STRAUSS, HAUER & FELD, 711 LOUISIANA STREET, SUITE 1900 SOUTH, HOUSTON, TX, 77002, US

(21) Appl. No.: 09/822,094

(22) Filed: Mar. 30, 2001

(51) Int. Cl. B41B 1/00; B41J 1/00; G06K 1/00

(52) U.S. Cl. 358/1.9

(57) ABSTRACT

A technique of automatic printer color correction includes accessing characterization data of the color ink cartridge and rendering consistent color for the color ink jet printer based on the characterization data. The characterization data can be stored on a website and accessed over the Internet by providing an identifier of the color ink cartridge. The identifier can, for example, be the serial number of the color ink cartridge. The characterization data—density data, for example—can be added to a printer profile for the color ink jet printer.

### BACKGROUND OF THE INVENTION

1. Field of the Invention

The present invention generally relates to automatic printer color correction and more particularly to automatic printer color correction based on characterization data of a color ink cartridge.

2. Description of the Related Art

Color management for imaging devices has been widespread among imaging devices including monitors, scanners, digital cameras and printers. For color management purposes, a printer manufacturer typically generates a generic printer profile for a particular model of color ink jet printer. To generate the printer profile, the printer manufacturer begins by printing a color test chart with the color ink jet printer model of interest. The color test chart, which carries the characteristics of the color ink jet printer on which it is printed, generally contains color patches for each shade of the colors of interest. A color measurement device such as a spectrophotometer or a calorimeter measures the spectral distribution or intensity of each color patch on the color test chart and provides the color data to a computer system of the printer manufacturer.

Color analysis software on the computer system analyzes the color data by comparing the color data for each patch of the color test chart to the corresponding standard color data such as defined by CIE (Commission International de l'Eclairage or International Commission on Illumination) color standards. A printer profile is then built based on this analysis to compensate or correct for the differences between the test color data and the standard color data. Based on the color analysis, a transformation matrix or a multi-dimensional look-up table of the printer profile can convert any standard color data to output color data for the color ink jet printer. The printer profile may further include a linearization table to linearize the standard color data before and after the matrix transformation.

A printer profile takes parameters into account such as printing process, ink types and rendering intention (e.g., perceptual, relative colorimetric, saturation or absolute calorimetric). The standard format for printer profiles as well as other types of device color profiles is described in the International Color Consortium (ICC) Specification ICC.1:1998-09. In general, when a user selects to print an image, printer or imaging software on the computer system retrieves the printer profile from the color management system for the color ink jet printer and performs printer color correction for the image based on the profile.

The above approach to printer color correction does not take into account that an original color ink cartridge in a color ink jet printer will later be replaced by a new color ink cartridge, which itself can be replaced. Once a replacement color ink cartridge is used in the color ink jet printer, the printer profile generated with test color data when the color ink jet printer included the original color ink cartridge is unlikely to be as effective in rendering consistent or perceptually uniform color for the color ink jet printer. A generic printer profile thus has been unreliable in rendering consistent color once the color ink jet printer includes a replacement color ink cartridge. Even creating a new printer profile after replacing a color ink cartridge is not a feasible option since a typical user lacks the color science expertise and specialized color measurement tools to do so.

### SUMMARY OF THE INVENTION

A technique of automatic printer color correction includes accessing characterization data of a color ink cartridge of a color ink jet printer and rendering consistent color for the color ink cartridge based on the characterization data. The characterization data can be stored on a website and accessed over the Internet by providing an identifier of the color ink cartridge. The identifier can, for example, be the serial number of the color ink cartridge. The characterization data—density data, for example—can be added to a printer profile for the color ink jet printer.

### BRIEF DESCRIPTION OF THE DRAWINGS

A better understanding of the present invention can be obtained when the following detailed description of the preferred embodiment is considered in conjunction with the following drawings, in which:

FIG. 1 is a block diagram illustrating an exemplary color ink cartridge characterization process and an exemplary automatic printer color correction process based on ink cartridge characterization data;

FIG. 2 is a flow chart further illustrating the color ink cartridge characterization process of FIG. 1;

FIG. 3 is a flow chart further illustrating the automatic ink cartridge color correction process of FIG. 1;

FIG. 4 is an illustration of an exemplary set of color step wedges including a cyan step wedge, a magenta step wedge and a yellow step wedge;

FIG. 5A is a chart illustrating exemplary curve fitted density data for the cyan step wedge of FIG. 4;

FIG. 5B is a chart illustrating exemplary curve fitted density data for the magenta step wedge of FIG. 4;

FIG. 5C is a chart illustrating exemplary curve fitted density data for the yellow step wedge of FIG. 4; and

FIG. 6 is an exemplary data flow diagram representing the printer profile of FIG. 1.

### DETAILED DESCRIPTION OF PREFERRED EMBODIMENT

Commonly-assigned U.S. patent application Ser. No. 09/362,080, entitled “METHOD OF COMPUTING A MATHEMATICAL REPRESENTATION TO REPRESENT THE INPUT-OUTPUT CHARACTERISTICS OF A COLOR DISPLAY DEVICE,” is hereby incorporated by reference as if set forth in its entirety.

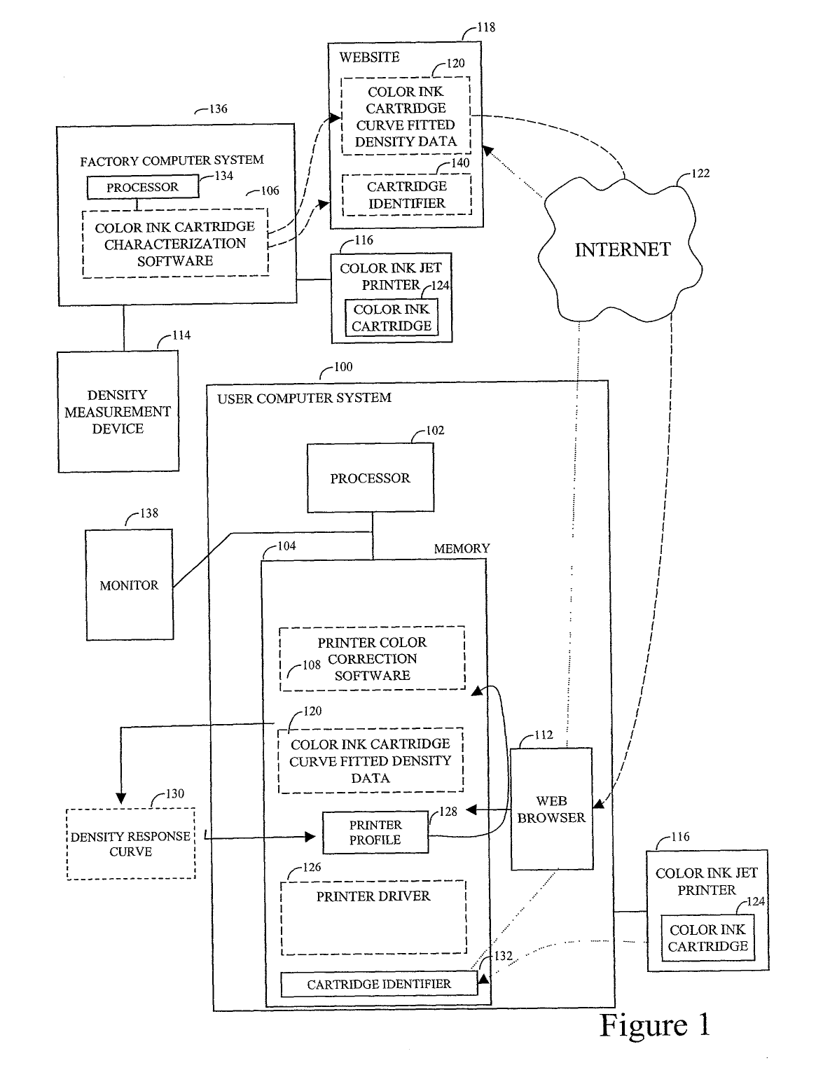

Turning now to the drawings, FIG. 1 illustrates an exemplary color ink cartridge characterization process and an exemplary automatic printer color correction process based on color ink cartridge characterization data. The color ink cartridge characterization process involves a factory computer system 136 including a processor 134 and color ink cartridge characterization software 106 executable by the processor 134. Certain typical components of a computer system are omitted from FIG. 1 for sake of clarity. The factory computer system 136 can be a computer system at an ink cartridge factory. Color ink cartridge characterization thus occurs at a manufacturing level or stage. In this way, no color measurement instruments are needed by a user.

The color ink cartridge 124 to be characterized is contained in the color ink jet printer 116 coupled to the factory computer system 136. A density measurement device 114 is shown coupled to the factory computer system 136 to measure density data of prints made with the color ink cartridge 124. The density measurement device 114 may be as simple as a densitometer or as complex as a spectrophotometer. While a densitometer measures density directly, a spectrophotometer obtains density measurements by measuring spectral reflectance and then calculating for density. An example of a suitable spectrophotometer is the GretagMacbeth Spectrolino that is used with the GretagMacbeth Spectro-Scan scanning table.

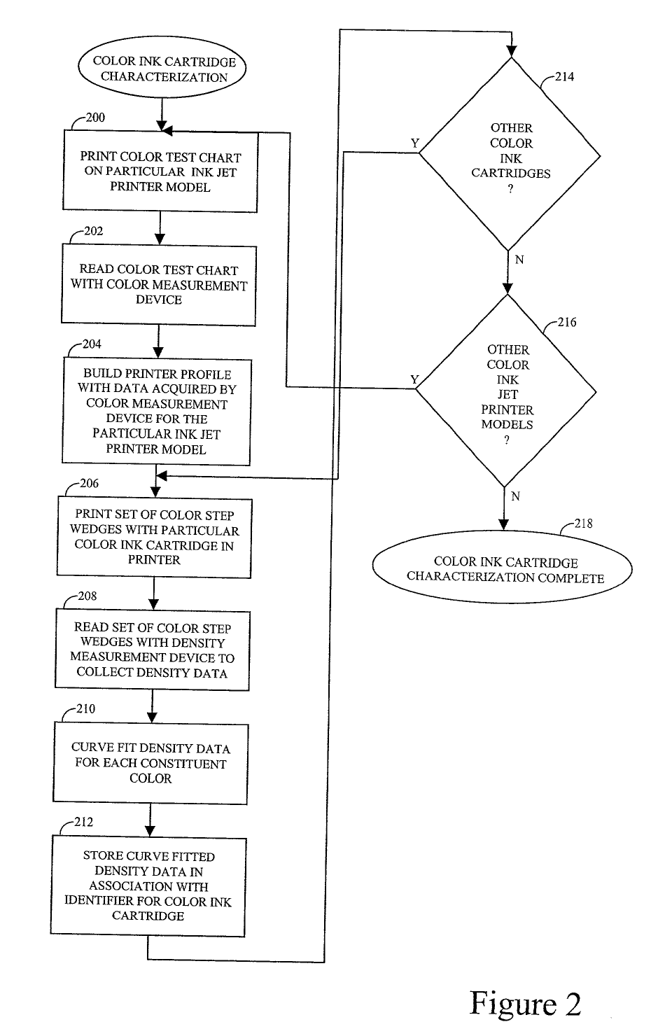

Using the color ink characterization software 106, an ink cartridge manufacturer characterizes the color ink cartridge 124 by curve fitting the density data for the color ink cartridge 124 measured by the density measurement device 114. Color ink cartridge curve fitted density data 120—characterization data for the color ink cartridge 124—is stored in association with a cartridge identifier 140 on a website 118. The website 118 can be a website of the ink cartridge or printer manufacturer. While a single factory computer system 136 and website 118 is shown, it should be understood that each ink cartridge or printer manufacturer may have its own factory computer system 136 and website 118. Alternatively, a single website 118 can store curve fitted density data 120 and a cartridge identifier 140 for each color ink cartridge for use with any color ink jet printer. Such a website 118 can be maintained by a third party supplied with ink cartridge characterization data and ink cartridge identifiers by each ink cartridge or printer manufacturer. The color ink cartridge characterization process is further described below in connection with FIG. 2.

The automatic printer color correction process involves a user computer system 100 including a processor 102 coupled to a monitor 138 and a memory 104. The memory 104 contains a printer driver 126 and printer color correction software 108 executable by the processor 102. The printer color correction software 108 and the printer driver 126 can be part of an operating system with support for ICC (International Color Consortium) profiles such as Microsoft Windows® 98 or 2000 which contains Integrated Color Management (ICM) 2.0 APIs (application programming interfaces). The user computer system 100 is connected to a color ink jet printer 116 containing a color ink cartridge 124. Same reference numerals are used for the color printer/cartridge combination coupled to the user computer system 100 and the printer/cartridge combination coupled to the factory computer system 136 since they represent the same type of printer/cartridge combination. That is, the printer/cartridge combination of the factory computer system 136 is of the same model or serial number as the printer/cartridge combination of the user computer system 100.

A cartridge identifier 132, which timely identifies the color ink cartridge 124 such as a serial number of the color ink cartridge 124, is read from a memory or other storage device of the color ink cartridge 124 and stored in the memory 104. Alternatively, the cartridge identifier 132 can be read from the color ink cartridge 124 without storage in the user computer system 100 or by employing storage in other media. As represented by the arrowed line from the cartridge identifier 132 to an Internet or web browser 112, from the web browser 112 to the Internet 122, and from the Internet 122 to the website 118, the cartridge identifier 132 can be transmitted or provided by the user computer system 100 over the Internet 122 to the website 118. If the website 118 determines that the cartridge identifier 132 from the user computer system 100 matches the cartridge identifier 140 from the factory computer system 136, then the curve fitted density data 120 associated with the cartridge identifier 140 is provided or transmitted over the Internet 122 to the user computer system 100. It should be understood that other techniques can be used for identifying or verifying the cartridge identifier 132.

As shown, the curve fitted density data 120 is directed through the web browser 112 and stored in the memory 104 of the user computer system 100. The curve fitted density data 120 for the color ink cartridge 124 is thereby accessed over the Internet based on the cartridge identifier 132. The curve fitted density data 120 represents a suitable color correction profile for the color ink cartridge 124. Stated another way, density data for the color ink cartridge 124 can be used to render color correctly for the color ink jet printer 116 based on the individual color ink cartridge 124. Though the website 118 illustrates one set of curve fitted density data 120 and the associated cartridge identifier 140, it should be understood that the website 118 can be used to maintain multiple sets of ink cartridge characterization data and the associated cartridge identifier for each model of ink cartridge that can be used in the color ink jet printer 116. As such, ink cartridge characterization data for any ink cartridge can be retrieved over the Internet 122. Similarly, the website 118 can maintain ink cartridge characterization data and cartridge identifiers for ink cartridges of multiple types of color ink jet printers. Therefore, ink cartridge characterization data for any ink cartridge of any color ink jet printer can be retrieved over the Internet as well. The ink cartridge characterization process shown in FIG. 1 is only illustrative since ink cartridge characterization data can be retrieved in other ways. For example, the ink cartridge characterization data could be retrieved from a memory of the color ink cartridge 124.

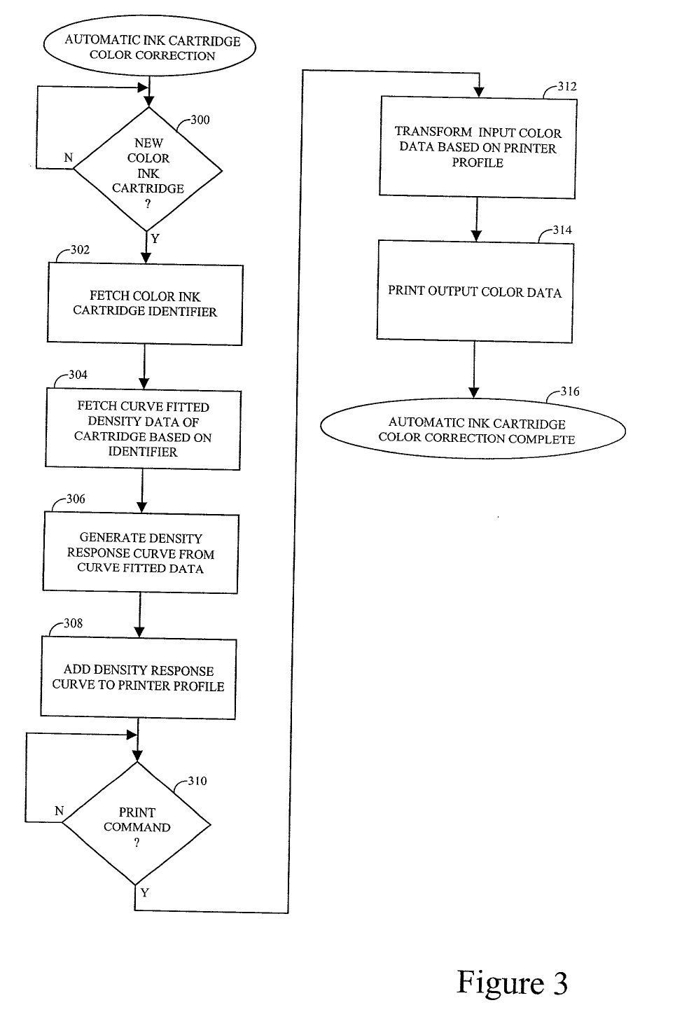

The curve fitted density data 120 is processed by the user computer system 100 to produce a density response curve 130, which is added to a printer profile 128. The printer profile 128 is used by the printer color correction software 108 to render consistent color for the color ink jet printer 116 based on the density response curve 130. Since the printer profile 128 includes the density response curve 130, the printer color correction performed by the printer color correction software 108 is specific to the color ink cartridge 124. Automatic printer correction for a particular color ink cartridge based on ink cartridge characterization data is further described below in connection with FIG. 3.

Referring to FIG. 2, an exemplary color ink cartridge characterization process is shown. Beginning in step 200, a color test chart is printed on a particular color ink jet printer model. The color test chart may contain color patches spanning the full gamut of the color printer 116. Next, in step 202, the color test chart is read or measured by a color measurement device such as a spectrophotometer or colorimeter. In step 204, a printer profile is built with the acquired color data. Steps 200-204 can represent the typical steps performed by a printer manufacturer to generate a generic printer profile for a particular model of color ink jet printer. Beyond steps 200-204 to obtain a generic printer profile, the disclosed techniques involve steps to individually characterize a color ink cartridge. A generic printer profile has not addressed ink cartridge variations.

In step 206, a set of color step wedges is printed by the color ink cartridge 124 of the color ink jet printer 116. The set of color step wedges can even be printed on three distinctive media types, glossy, coated, and plain paper, since the density responses on these media can be quite different. For sake of improved accuracy, the color ink jet printer 116 should be aligned and its nozzle should be cleaned before printing the set of color step wedges. It may advisable for the factory to control temperature and humidity so as to keep variations to a minimum. The factory should also dry the prints before any measuring.

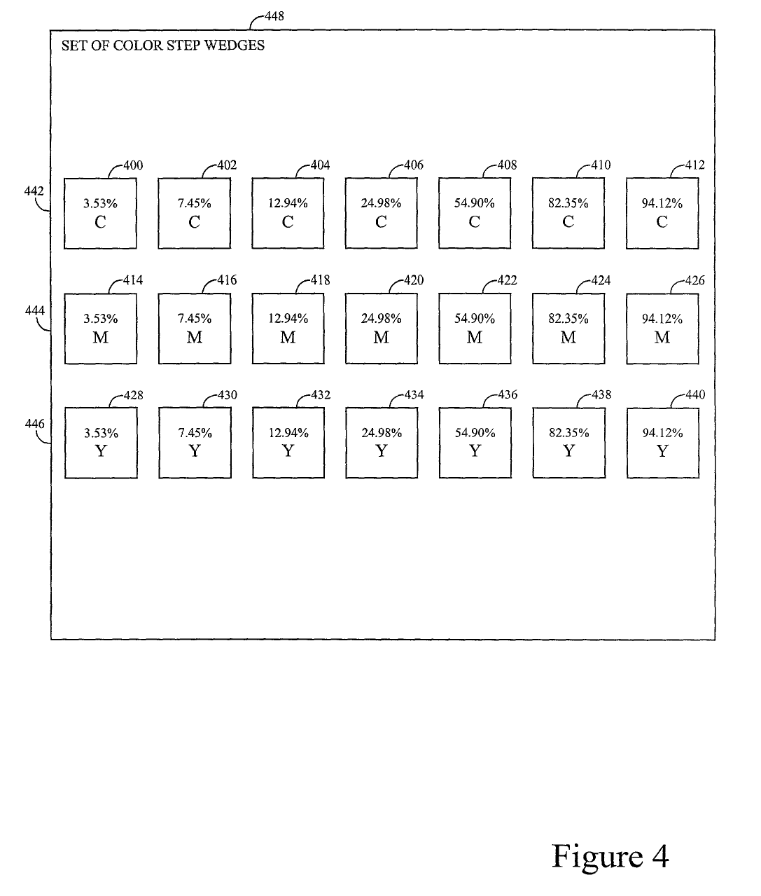

Referring to FIG. 4, an illustration of an exemplary set of color step wedges 448 is shown. The set of color step wedges 448 serves as a customized test color chart for use in characterizing the color ink cartridge 124. Unlike the test color chart used in generating the printer profile 128, the customized test color chart may only include patches for certain shades of the constituent colors, which for this example are cyan (C), magenta (M) and yellow (Y). An example of a suitable test color chart for cyan, magenta, yellow and black as constituent colors is the TC3.5 CMYK test chart of GretagMacbeth. The test color chart of FIG. 4 is shown as including a cyan step wedge 442, a magenta step wedge 444 and a yellow step wedge 446. It should be understood that a different combination of constituent colors can alternatively be used. For example, the constituent colors can by cyan, magenta, yellow and black.

Each row of color patches can be referred to as “step wedge” since each patch on a row represents a different dot percentage of a constituent color. The patches on a single row collectively provide test points with incremented dot percentages for effectively evaluating a constituent color. Color patches 400-412 of the cyan step wedge 442 respectively represent 3.53%, 7.45%, 12.94%, 24.98%, 54.9%, 82.35% and 94.12% of cyan dots; color patches 414-426 of the magenta step wedge 444 respectively represent 3.53%, 7.45%, 12.94%, 24.98%, 54.9%, 82.35% and 94.12% of magenta dots; and color patches 428-440 of the yellow step wedge 446 respectively represent 3.53%, 7.45%, 12.94%, 24.98%, 54.9%, 82.35% and 94.12% of yellow dots. It should be understood that alternatively the customized test chart can include different dot percentages. For example, five color patches could be used for each constituent color representing 20, 40, 60, 80 and 100 dot percentages. Another example would be seven color patches for each constituent color representing 10, 20, 40, 50, 60, 80 and 100 dot percentages.

Returning to FIG. 2, in step 208, the density measurement device 114 measures density for the set of color step wedges 448. The GretagMacbeth profile system (including the Spectrolino and Spectroscan) can achieve +/−0.01D repeatibility. “D” represents a unit of density. The specific measurement unit for density can be Status T—the accepted standard in the United States for color reflection densitometers—which is a wide band color reflection densitometer response. In this example, the device 114 will collect seven density data points corresponding to test points with different dot percentages for each constituent color. Next, in step 210, the density data points for each constituent color are curve fitted to a non-linear curve to model the density data for the constituent color. The non-linear curve can be a polynomial curve for instance. The use of a polynomial curve in the context of color data for a display device has been described in the commonly-assigned U.S. patent application Ser. No. 09/362,080, entitled “METHOD OF COMPUTING A MATHEMATICAL REPRESENTATION TO REPRESENT THE INPUT-OUTPUT CHARACTERISTICS OF A COLOR DISPLAY DEVICE.” Least squares fitting techniques can be performed by the color ink cartridge software 106 to fit density data points for a constituent color to a nonlinear curve. The color ink cartridge characterization software 106 can be spreadsheet or other software with curve fitting or similar data plotting or manipulation capabilities.

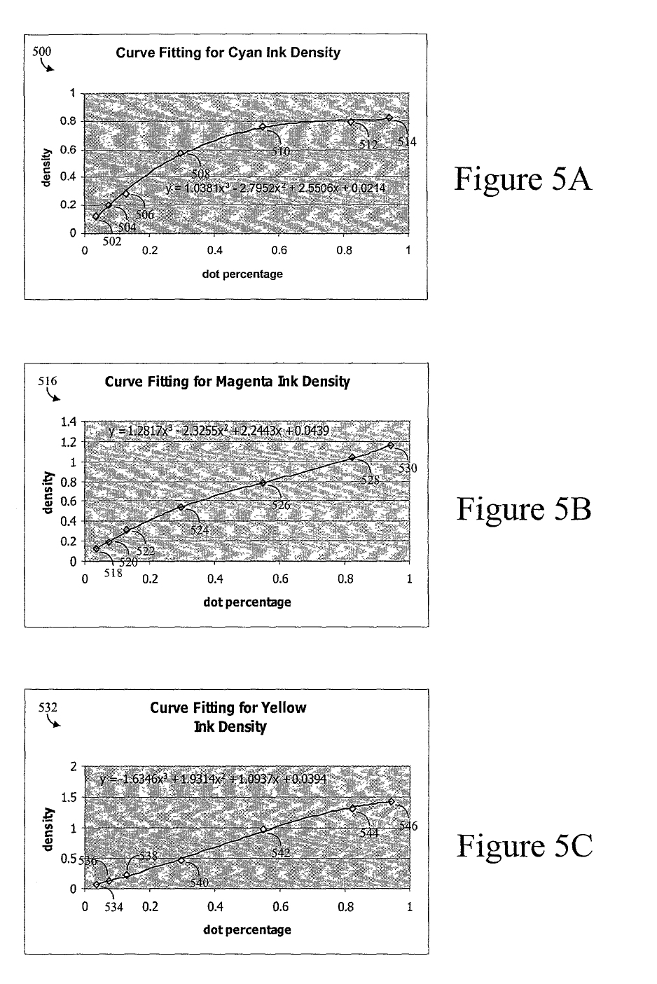

Referring to FIGS. 5A-5C, exemplary curve fitted density data for the cyan step wedge 442, magenta step wedge 444 and yellow step wedge 446 respectively is shown. In FIG. 5A, the curve fitted density data for the cyan step wedge 442 is shown as a cyan step wedge density curve 500. The abscissa or horizontal axis of the chart represents the dot percentage of the cyan step wedge 442, and the ordinate or vertical axis of the chart represents the corresponding density of the cyan step wedge 430. Similarly, the curve fitted density data for the magenta step wedge 444 is shown as a magenta step wedge density curve 516, and the curve fitted density data for the yellow step wedge 446 is shown as a yellow step wedge density curve 532. As can be seen from FIGS. 5B and 5C, dot percentage and density for the magenta step wedge 444 and the yellow step wedge 446 are represented respectively on the same axes as with the cyan step wedge 442. For each step wedge chart, the abscissa ranges from a dot percentage of zero (0) to one hundred (100). For FIG. 5A, the ordinate ranges from a density of zero to 1. For FIG. 5B, the ordinate ranges from a density of 0 to 1.4. For FIG. 5C, the ordinate ranges from a density of 0 to 2.

From the seven cyan density data points 502-514 derived from the cyan step wedge 442, the polynomial curve 500 shown in FIG. 5A is fitted. The polynomial curve 500 is represented by the equation, y=1.0381x³−2.7952x²+2.5506x+0.0214. From the seven magenta density data points 518-530 derived from the magenta step wedge 444, the polynomial curve 516 shown in FIG. 5B is fitted. The polynomial curve 516 is represented by the equation, y=1.2817x³−2.3255x²+2.2443x+0.0439. From the seven yellow density data points 534-546 derived from the yellow step wedge 446, the polynomial curve 532 shown in FIG. 5C is fitted. The polynomial curve 532 is represented by the equation, y=−1.6346x³+1.9314x²+1.0937x+0.0394. For the exemplary equations in FIGS. 5A-5C, each polynomial equation is at least a third order polynomial equation.

Returning to FIG. 2, in step 212, the curve fitted density data 120 for each constituent color is stored in association with the color ink cartridge identifier 136. More particularly, the coefficients representing the curve fitted density data 120 can be stored. For example, in the case of the density data of FIGS. 5A-5C, the coefficients 1.0381, −2.7952, 2.5506 and 0.0214 of the cyan polynomial equation shown in FIG. 5A, the coefficients 1.2817, −2.3255, 2.2443 and 0.0439 of the magenta polynomial equation shown in FIG. 5B and the coefficients −1.6346, 1.9314, 1.0937 and 0.0394 of the yellow polynomial equation shown in FIG. 5C can be stored. The stored coefficients are specific to the particular color ink cartridge 124. The number of coefficients stored for each constituent color will depend upon the appropriate number of coefficients or order of the non-linear equation to sufficiently express the density data as a non-linear curve.

From step 212, the process proceeds to step 214 where it is determined if there are any other color ink jet cartridges. If so, then the process returns to step 206 so that the process may generate curve fitted density data for another color ink cartridge. In this way, each available color ink cartridge for the particular color ink jet printer model is characterized. If it is determined in step 214 that there are no other color ink cartridges, then the process proceeds to step 216 where it is determined if there are other color ink jet printer models. If so, then the process returns to step 200 so a printer profile can be generated for each available color ink jet printer model and each available color ink cartridge for each printer model can be characterized. If there are no other color ink jet printer models available, then the color ink characterization process is completed in step 218. With this ink cartridge color characterization process, each color ink cartridge for each color ink jet printer model can be characterized at a manufacturing level or stage.

Referring to FIG. 3, an exemplary automatic ink cartridge color correction process based on ink cartridge characterization data is shown. Beginning in step 300, it is determined if a new color ink cartridge has been added to the color ink jet printer 116 connected to the user computer system 100. If a new color ink cartridge has not been added, then the process remains at step 300. If a new color ink cartridge has been added, then the cartridge identifier 132 is fetched from the color ink cartridge 124 in step 302. Next, in step 304, the cartridge identifier 132 is transmitted or provided over the Internet 122 to the website 118 to fetch the curve fitted density data 120 for the color ink cartridge 124 from the website 118. The curve fitted density data 120 can be fetched through a look-up function based on the cartridge identifier 132. A look-up table to implement the look-up function can associate curve fitted density data for any color ink cartridge with the cartridge identifier for that color ink cartridge. It should be understood that other techniques can be used for fetching the curve fitted density data 120 for the color ink cartridge 124. As a result of step 304, the curve fitted density data 120 or other suitable ink cartridge characterization data is retrieved at the user level.

In step 306, the curve fitted density data 120 is processed to generate a density response curve 130 which in step 308 is added to the printer profile 128. Step 306 is generally directed to reconstructing an ink cartridge color correction profile from ink cartridge characterization data. One approach is to resample or expand the curve fitted density data 120 by inserting a range of dot percentage values into the “x” variable of the equation(s) for the curve fitted density data 120 to generate a number of density values. The “x” variable can be any dot percentage ranging from 0% to 100%. The number of dot percentage values used to expand the curve fitted density data 120 may depend upon the desired resolution for the printer profile 128. The density response curve 130, which may take the form of a look-up table of the density values, can be added to the printer profile 128 as a responseCurveSet 16Type tag. For this type of tag, a generic density response curve that represents a statistical mean or average for density data of typical cartridges excluding the outermost density data can be used as a reference response. A responseCurveSet16Type tag is generally described on pages 69-71 of the ICC Specification ICC.1:1998-09. Steps 306 and 308 represent one approach to including color ink cartridge density data in the printer profile 128. An alternative approach is to include the curve fitted density data 120 in a linearization look-up table of the printer profile 128. Step 308 is generally directed to including ink cartridge characterization data in a meaningful form into the printer profile 128.

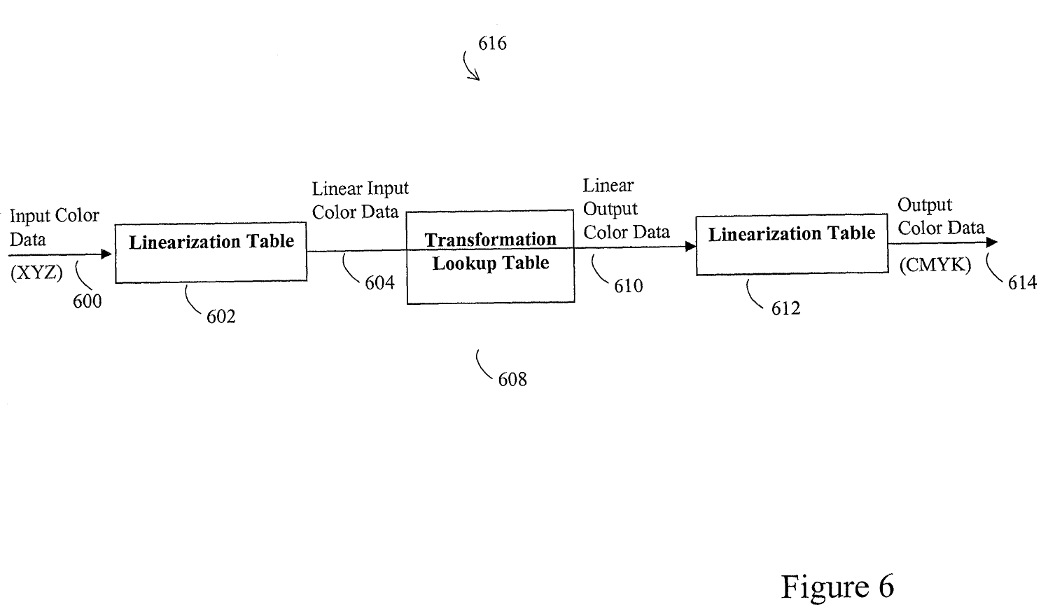

Next, in step 310, it is determined if a print command has been selected by a user. If not, then the process remains at step 310. If a print command has been selected, then the process proceeds to step 312 where input color data is transformed based on the printer profile 128. Since the printer profile 128 includes ink cartridge characterization data, consistent color can be rendered for the ink cartridge 124. Referring to FIG. 6, an exemplary data flow representation 616 for the printer profile 128 is shown. Input color data 600 referenced to an XYZ or XYZData color space is provided to a linearization table 602. The input color data 600, which can be in the form of CIE XYZ tristimulus values obtained from a display device color profile, is linearized by the linearization table 602 to produce linear input color data 604. A transformation look-up table 608 receives the linear input color data 604 and transforms the linear input color data to linear output color data 610. The look-up table 608 is a 3-D look-up table in an appropriate resolution. A linearization table 612 linearizes the linear output color data 610 to produce output color data 614 referenced to a CMYK or cmykData color space, the color space understood by most color ink jet printers.

Returning to FIG. 3, in step 314, output color data 610 is printed by the color ink jet printer 116. From step 314, the automatic ink cartridge color correction process is completed in step 316. Since the color ink cartridge characterization data can be part of the transformation look-up table 608 or the linearization table 602, the color ink characterization data is taken into account in the performed transformation.

The disclosed techniques of color ink cartridge characterization and automatic color correction for ink cartridge variations can greatly enhance color management for ink jet printers. It has been found by Applicants that even slight differences in ink characteristics of color ink cartridges can produce noticeable color differences to a user. For example, with a typical generic printer profile for a particular model of color ink jet printer, it has been found by Applicants that a test chart printed from different color ink cartridges in the same color ink jet printer does not exhibit consistent color. In fact, prints from ink cartridges with extreme ink cartridge variations exhibit color imbalance. That is, in certain cases, different colors are rendered by different ink cartridges. These findings reveal that color ink cartridge variation is a significant factor in color consistency for color ink jet printers.

It has also been found by Applicants that ink cartridge variations affecting color include hue and concentration variations in ink formulations and drop size variations in cartridge manufacturing. That is, color ink cartridge variations can be from the ink or the printing process. The former can contribute to both hue shift and ink density variation from batch to batch depending on the level of quality control on mixing inks at the manufacturing level. The latter can contribute to the density response for various dot percentages, depending on differences in printer components such as the heater and the nozzle. It has been found by Applicants that hue shift among ink cartridges is relatively small compared to ink density variations among ink cartridges. Density is therefore sufficient to account for ink differences among ink cartridges. The above factors reflect the finding by Applicants that the density responses of individual color ink cartridges, including the maximum density and the difference between minimum density and the maximum density, can be quite different. By characterizing individual ink cartridges based on density data, color management per ink cartridge can be achieved. The density of an ink cartridge can be compared to an average ink cartridge density value or other predetermined ink cartridge density level. If the density of the ink cartridge is above an average ink cartridge density value or other predetermined ink cartridge density level, then color management can compensate by lightening the colors of the print to match the predetermined ink cartridge density level. If the density of the ink cartridge is below the average ink cartridge density value or other predetermined ink cartridge density level, then color management can compensate by darkening the colors of the print to match the predetermined ink cartridge density level.

Printer color correction based on ink cartridge characterization data is automatic in the sense that the process is transparent to the user. For instance, ink cartridge characterization data is retrieved without user intervention based on an identifier for the color ink cartridge. Printer color correction is also automatic at the user level in the sense that each color ink cartridge is individually characterized at the manufacturing level or stage.

The foregoing disclosure and description of various embodiments are illustrative and explanatory thereof, and various changes in the color spaces, color ink cartridge types, color ink jet printer types, color ink cartridge identifiers, color ink cartridge identifier handling techniques, printer profiles, printer color profiling techniques, density data curve fitting, density measurement techniques, test charts, ink cartridge characterization data, cartridge manufacturing, and ink cartridge characterization data retrieval techniques, as well as in the details of the illustrated software and hardware and construction and method of operation may be made without departing from the spirit of the invention.

We claim:

1. A method of printer color correction, comprising the steps of:
accessing characterization data of a color ink cartridge of a color ink jet printer; and
rendering consistent color for the color ink jet printer based on the characterization data.

2. The method of claim 1, wherein the characterization data comprises density data of the color ink cartridge.

3. The method of claim 1, the rendering consistent color step comprising the step of:
adding the characterization data to a printer profile for the color ink jet printer.

4. The method of claim 1, further comprising the step of:
reading an identifier for the color ink cartridge associated with the characterization data of the color ink cartridge to perform the accessing step based on the identifier.

5. The method of claim 4, wherein the identifier comprises a serial number of the color ink cartridge.

6. The method of claim 1, the accessing step comprising the step of:
accessing the characterization data over the Internet.

7. A printer color correction program, comprising:
code to access characterization data of a color ink cartridge of a color ink jet printer; and
code to render consistent color for the color ink jet printer based on the characterization data.

8. The printer color correction program of claim 7, wherein the characterization data comprises density data of the color ink cartridge.

9. The printer color correction program of claim 7, the code to render consistent color comprising:
code to add the characterization data to a printer profile for the color ink jet printer.

10. The printer color correction program of claim 7, further comprising:
code to read an identifier for the color ink cartridge associated with the characterization data of the color ink cartridge,
wherein the code to access characterization data accesses the characterization data based on the identifier.

11. The printer color correction program of claim 10, wherein the identifier comprises a serial number of the color ink cartridge.

12. The printer color correction program of claim 7, the code to access comprising:
code to access the characterization data of the color ink cartridge over the Internet.

13. A color ink cartridge characterization program, comprising:
code to characterize a color ink cartridge of a color ink jet printer to create ink cartridge characterization data for the color ink cartridge; and
code to store the ink cartridge characterization data in association with an identifier for the color ink cartridge.

14. The color ink cartridge characterization program of claim 13, wherein the ink cartridge characterization data comprises density data of the color ink cartridge.

15. The color ink cartridge characterization program of claim 14, wherein the density data comprises curve fitted density data of the color ink cartridge.

16. A printer color correction system, comprising:
a means for accessing characterization data of a color ink cartridge of a color ink jet printer; and
a means for rendering consistent color for the color ink jet printer based on the characterization data.

17. The printer color correction system of claim 16, wherein the characterization data comprises density data of the color ink cartridge.

18. The printer color correction system of claim 17, wherein the density data comprises curve fitted density data of the color ink cartridge.

19. A method of color ink cartridge characterization, comprising the steps of:
characterizing a color ink cartridge of a color ink jet printer to create ink cartridge characterization data for the color ink cartridge; and
storing the ink cartridge characterization data in association with an identifier for the color ink cartridge.

20. The method of claim 19, wherein the ink cartridge characterization data comprises density data of the color ink cartridge.

21. The method of claim 20, wherein the density data comprises curve fitted density data of the color ink cartridge.

22. The method of claim 19, the storing step comprising the step of:
storing the ink cartridge characterization data on a website.

23. A computer system, comprising:
a processor; and
a printer color correction program executable by the processor, the program comprising:
code to access characterization data of a color ink cartridge of a color ink jet printer; and
code to render consistent color for the color ink jet printer based on the characterization data.

24. The computer system of claim 23, the printer color correction program further comprising:
code to read an identifier for the color ink cartridge associated with the characterization data of the color ink cartridge,
wherein the code to access characterization data accesses the characterization data based on the identifier.

25. The computer system of claim 23, wherein the characterization data comprises density data of the color ink cartridge.

26. The computer system of claim 25, the code to render consistent color comprising:
code to compare the density data to a predetermined ink cartridge density level; and
code to adjust color for the color ink jet printer to match the predetermined ink cartridge density level.

27. A color ink cartridge characterization system, comprising:
a means for characterizing a color ink cartridge of a color ink jet printer to create ink cartridge characterization data for the color ink cartridge; and
a means for storing the ink cartridge characterization data in association with an identifier for the color ink cartridge.

28. The color ink cartridge characterization program of claim 27, wherein the color ink cartridge characterization data comprises density data of the color ink cartridge.

29. The color ink cartridge characterization program of claim 28, wherein the density data comprises curve fitted density data of the color ink cartridge.
